(19) United States
(12) Patent Application Publication
(10) Pub. No.: US 2019/0011784 A1
(43) Pub. Date: Jan. 10, 2019

(54) PIXEL STRUCTURE AND DISPLAY PANEL APPLYING THE SAME

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/735,341

(22) PCT Filed: Apr. 14, 2017
(86) PCT No.: PCT/CN2017/080554

§ 371 Date: Dec. 11, 2017

(30) Foreign Application Priority Data
Dec. 30, 2016 (CN) 201611258617.9

(51) Int. Cl. G02F 1/1343; G02F 1/1368; G02F 1/1335; G02F 1/1337

(52) U.S. Cl. CPC G02F 1/134309; G02F 1/1368; G02F 1/133528; G02F 1/13439; G02F 2203/30; G02F 2001/133567; G02F 2001/133562; G02F 2001/133742; G02F 1/1337

(57) ABSTRACT

This application relates to a pixel structure and a display panel applying the same. The pixel structure includes: a plurality of pixel units, where each of the pixel units includes at least one light penetration area, a light penetration effects of the pixel units are distinguished according to different retardations and an area ratio, and a shape of the pixel structure is a circle, an ellipse, or a helical shape.

### BACKGROUND

### Technical Field

This application relates to a design method, and in particular, to a pixel structure and a display panel applying the same.

### Related Art

A liquid crystal display panel usually includes a color filter (CF) substrate, a thin film transistor array substrate (TFT Array Substrate), and a liquid crystal layer (LC Layer) disposed between the two substrates. An operating principle of the liquid crystal display panel is applying a drive voltage to two glass substrates to control rotation of liquid crystal molecules of the liquid crystal layer and refract a light ray of a backlight module to generate a picture. According to different liquid crystal orientation manners, currently, liquid crystal display panels in the mainstream market may be classified into the following several types: a vertical alignment (VA) type, a twisted nematic (TN) type or a super twisted nematic (STN) type, an in-plane switching (IPS) type, and a fringe field switching (FFS) type.

A liquid crystal display device of the vertical alignment (VA) mode is, for example, a patterned vertical alignment (PVA) liquid crystal display or a multi-domain vertical alignment (MVA) liquid crystal display device. A liquid crystal display device of the PVA type produces a wide viewing angle effect by using an edge field effect and a compensation plate. In a liquid crystal display device of the MVA type, a pixel is divided into a plurality of regions, and a protrusion or a particular pattern structure is used, so that liquid crystal molecules located in different regions tilt to different directions, so as to achieve a wide viewing angle and produce an effect improving a transmittance.

In an IPS mode or an FFS mode, by means of applying an electrical field including a component basically parallel to a substrate, liquid crystal molecules act correspondingly in a direction parallel to a plane of the substrate, so that the liquid crystal molecules are driven. A liquid crystal display panel of the IPS type and a liquid crystal display panel of the FFS type both have an advantage of a wide viewing angle. However, because a wavelength of blue light is relatively short, as compared with red light and green light, the blue light needs relatively small retardation to achieve a same transmittance, and voltage-transmittance (V-T) curves of the red light, the green light, and the blue light are different. Moreover, the red light, the green light, and the blue light have different transmittances in film surfaces, such as a polyimide (PI) film, a planarization layer (PFA), and a coating layer (OC), in a panel, and consequently, a color shift problem occurs.

In the MVA mode, currently, a mainstream approach is dividing a pixel region into a bright region and a dark region. Therefore, optical performance may be formed by mixing two V-T characteristics. In addition, in a case of a large viewing angle, a whitening problem of a middle grayscale may be effectively suppressed by appropriately adjusting an area ratio of the bright region to the dark region.

### SUMMARY

To resolve the foregoing technical problem, this application is directed to providing a design method, and in particular, relates to a pixel structure and a display panel applying the same, so as to not only effectively resolve a color shift problem but also effectively improve a designed pixel aperture ratio.

The following technical solutions are used to achieve the objective of this application and resolve the technical problem of this application. A pixel structure proposed according to this application comprises a plurality of pixel units, where each of the pixel units comprises at least one light penetration area, and a light penetration effects of the pixel units are distinguished according to different retardations and an area ratio, and a shape of the pixel structure is a circle, an ellipse, or a helical shape.

The following technical measures may be taken to further achieve the objective of this application and resolve the technical problem of this application.

A liquid crystal display panel comprises a first substrate, a second substrate disposed opposite to the first substrate, and a liquid crystal layer disposed between the first substrate and the second substrate, and further comprises the pixel structure disposed between the first substrate and the second substrate. Moreover, the liquid crystal display panel further comprises a first polarizer disposed on an outer surface of the first substrate, and a second polarizer disposed on an outer surface of the second substrate, where a polarization direction of the first polarizer and a polarization direction of the second polarizer are parallel to each other.

In an embodiment of this application, the pixel units divide a pixel unit equivalent region into at least three regions by using different phase difference factors.

In an embodiment of this application, the pixel units divide a pixel unit equivalent region into at least three regions by using different gradient terrain factors of a passivation layer.

In an embodiment of this application, an etching process of the passivation layer is changed by using a half tone process procedure.

In an embodiment of this application, a first light penetration area comprising four primary light penetration areas, a second light penetration area comprising four secondary light penetration areas, and a third light penetration area comprising four secondary two-light penetration areas are further comprised.

In an embodiment of this application, the pixel region is divided into three different gradient terrain depths and divide the pixel structure according to the three different gradient terrain depths into an inner layer, a middle layer, and an outer layer are all circular, a pixel electrode covers on the pixel structure, and design of a slit is reserved.

In an embodiment of this application, an arrangement manner of the pixel structure is a strip-shaped arrangement or a delta-shaped arrangement.

In an embodiment of this application, a thin film transistor is further comprised and is used to drive the entire pixel.

By means of design of an arc-shaped pixel electrode, in this application, a large viewing angle contrast may be alleviated, and a large viewing angle color shift problem of the liquid crystal display panel may be effectively resolved.

### BRIEF DESCRIPTION OF THE DRAWINGS

FIG. 1a is a transmittance-grayscale value curve corresponding to a color shift angle in a case of a VA liquid crystal display device at viewing angles of 0 degree, 45 degrees, and 60 degrees according to an embodiment of this application;

FIG. 1b is a brightness-grayscale curve corresponding to mixing of two improved color shift angles according to an embodiment of this application;

FIG. 2 is a mixed low color shift region model according to an embodiment of this application;

FIG. 3 is a schematic diagram of a liquid crystal display panel according to an embodiment of this application;

FIG. 3a is a schematic diagram of a circular electrode pixel region of a pixel structure according to an embodiment of this application;

FIG. 3b shows retardations of three types of liquid crystal layers of a pixel structure according to an embodiment of this application;

FIG. 4a explains three types of GAMMA curves by using a V-T curve according to an embodiment of this application;

FIG. 4b explains three types of GAMMA curves by using a transmittance-grayscale value according to an embodiment of this application;

FIG. 5 is a schematic diagram of manufacturing a pixel structure in a gradient shape by using a half tone process procedure according to an embodiment of this application;

FIG. 6a is a schematic diagram of an electrode pixel shape according to an embodiment of this application; and

FIG. 6b is a schematic diagram of an arrangement manner of a pixel structure according to an embodiment of this application.

### DETAILED DESCRIPTION

The following embodiments are described with reference to accompany drawings, and are used to illustrate particular embodiments that can be implemented in this application. The directional terms mentioned in the present invention, such as “above”, “below”, “front”, “back”, “left”, “right”, “inner”, “outer”, and “side” refer to the directions in the accompanying drawings. Therefore, the directional terms are used to describe and understand this application instead of limiting this application.

The accompany drawings and description are considered to be substantially illustrative instead of limitative. In the figures, units with similar structures are represented by same numerals. In addition, to facilitate understanding and description, a size and a thickness of each component shown in the accompany drawings are arbitrarily shown. However, no limitation is imposed in this application.

In the accompany drawings, for a purpose of clarity, thicknesses of a layer, a film, a panel, a region, and the like are exaggerated. In the accompany drawings, to facilitate understanding and description, thicknesses of some layers and regions are exaggerated. It should be understood that when a component, for example, a layer, a film, a region, or a substrate is described as “being located” “on” another component, the component may be directly on the another component, or an intermediate component exists.

In addition, in the specification, unless clearly described as opposite, the word “include” is understood to mean including the component but not excluding any other components. In addition, in the description, “being located on . . . ” means being located above or below a target component, but does not mean necessity of being located on the top based on a gravity direction.

To further describe technical means adopted in this application for achieving a predetermined invention objective and effects of this application, with reference to the accompany drawings and preferred embodiments, the following describes in detail a pixel structure and a display panel applying the same according to this application, and their embodiments, structures, features, and effects.

A liquid crystal display device of this application may include a backlight module and a liquid crystal display panel. The liquid crystal display panel may include a thin film transistor (TFT) substrate, a color filter (Color Filter, CF) substrate, and a liquid crystal layer formed between the two substrates.

In an embodiment, the liquid crystal display panel of this application may be a display panel with a curved surface, or the liquid crystal display panel of this application may be a display device with a curved surface.

In an embodiment, the thin film transistor (TFT) or another active switch and the color filter (CF) of this application may be formed on a same substrate.

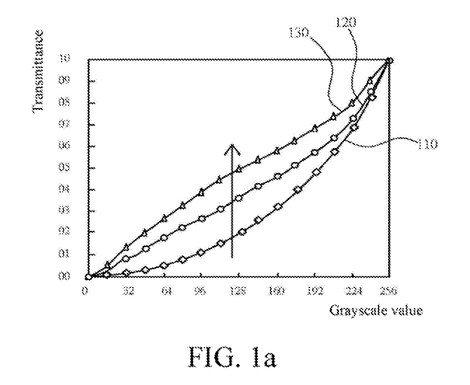

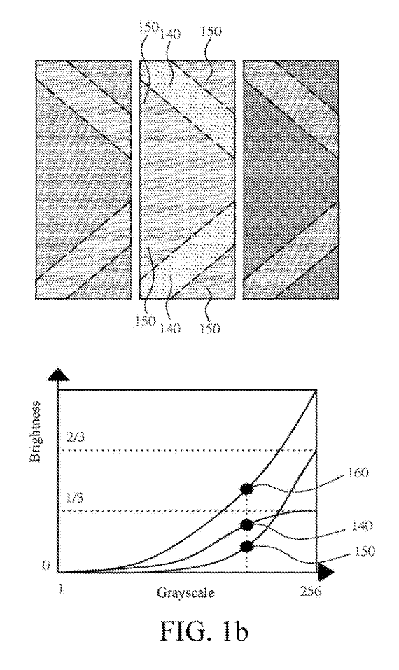

FIG. 1a is a transmittance-grayscale value curve corresponding to a color shift angle in a case of a VA liquid crystal display device at viewing angles of 0 degree, 45 degrees, and 60 degrees. Referring to FIG. 1a, FIG. 1a shows a transmittance-grayscale value curve 110 corresponding to a color shift viewing angle of 0 degree, a transmittance-grayscale value curve 120 corresponding to a color shift viewing angle of 45 degrees, and a transmittance-grayscale value curve 130 corresponding to a color shift viewing angle of 60 degrees. Therefore, a larger color shift viewing angle indicates a greater brightness transmittance in a same grayscale value.

FIG. 1b is a brightness-grayscale curve corresponding to mixing of two improved color shift angles. Referring to FIG. 1b, in an embodiment of this application, in the MVA mode, currently, a mainstream approach is dividing a pixel region into a bright region and a dark region. Therefore, optical performance may be formed by mixing two V-T characteristics. In addition, in a case of a large viewing angle, a whitening problem of a middle grayscale may be effectively suppressed by appropriately adjusting an area ratio of the bright region to the dark region. A bright region pixel 140 and a dark region pixel 150 are mixed with each other and adjusted to form a pixel 160 in a brightness-grayscale pattern.

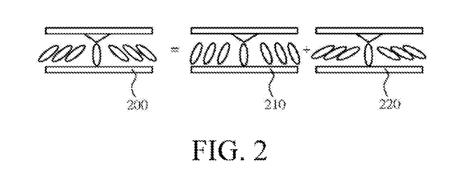

FIG. 2 is a mixed low color shift region model. Referring to FIG. 2, in an embodiment of this application, a main principle of a common low color shift technology is cutting conventional four regions into eight regions by means of voltage division or an additional driving manner. Therefore, there is an effect of multi-category compensation during viewing at a large viewing angle. For example, a sub-low color shift region 210 and a primary low color shift region 220 are mixed to form a low color shift region 200.

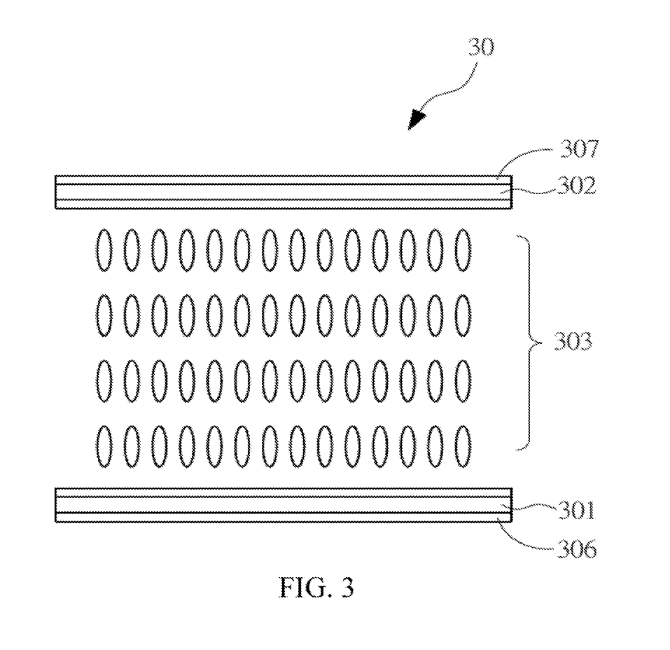

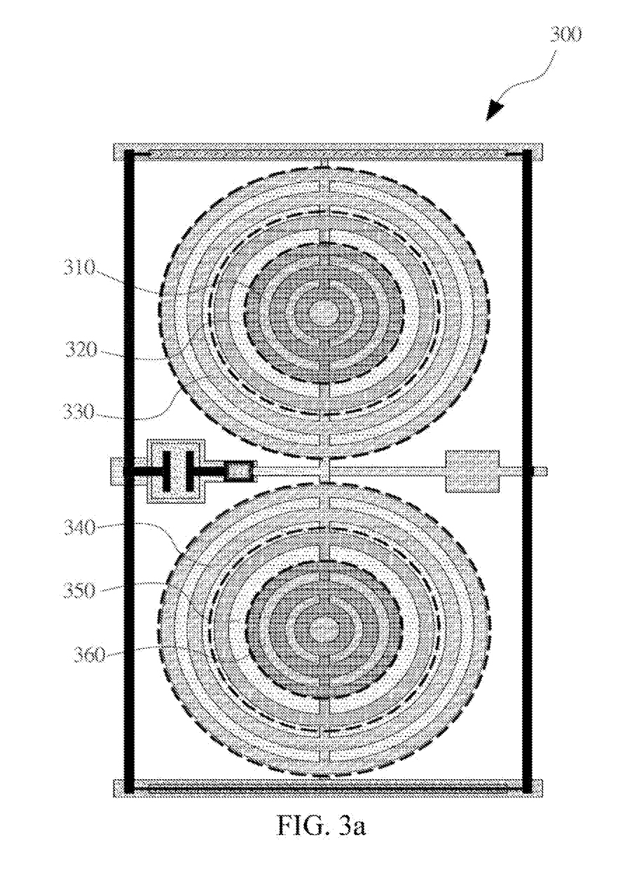

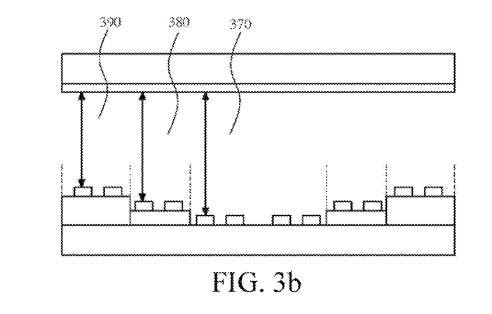

FIG. 3 is a schematic diagram of a liquid crystal display panel 30 according to an embodiment of this application, and FIG. 3a is a schematic diagram of a circular electrode pixel region of a pixel structure according to an embodiment of this application. Referring to FIG. 3 and FIG. 3a, in an embodiment of this application, the liquid crystal display panel 30 includes: a first substrate 301 (for example, a thin film transistor substrate); a second substrate 302 (for example, a color filter substrate), disposed opposite to the first substrate 301; and a liquid crystal layer 303, disposed between the first substrate 301 and the second substrate 302. The liquid crystal display panel 30 further includes the pixel structure, disposed between the first substrate and the second substrate (for example, is located on a surface of the first substrate) and including: a plurality of pixel units 300, where the pixel units 300 include three regions, namely, a first light penetration area (310, 360), a second light penetration area (320, 350), and a third light penetration area (330, 340), light penetration effects of the three transparent regions are distinguished according to different depths and an area ratio, and are disposed between the first substrate 301 and the second substrate 302. Moreover, the liquid crystal display panel 30 further includes a first polarizer 306 disposed on an outer surface of the first substrate 301, and a second polarizer 307 disposed on an outer surface of the second substrate 302. A polarization direction of the first polarizer 306 and a polarization direction of the second polarizer 307 are parallel to each other.

In an embodiment of this application, a display apparatus of this application includes a backlight module and further includes a liquid crystal display panel 30, including: a first substrate 301 (for example, a thin film transistor substrate); a second substrate 302 (for example, a color filter substrate), disposed opposite to the first substrate 301; a liquid crystal layer 303, disposed between the first substrate 301 and the second substrate 302. The liquid crystal display panel 30 further includes the pixel structure, disposed between the first substrate and the second substrate (for example, is located on a surface of the first substrate) and including: a plurality of pixel units 300, where the pixel units 300 include three regions, namely, a first light penetration area (310, 360), a second light penetration area (320, 350), and a third light penetration area (330, 340), a light penetration effects of the three transparent regions are distinguished according to different depths and an area ratio, and are disposed between the first substrate 301 and the second substrate 302. Moreover, the liquid crystal display panel 30 further includes a first polarizer 306 disposed on an outer surface of the first substrate 301, and a second polarizer 307 disposed on an outer surface of the second substrate 302. A polarization direction of the first polarizer 306 and a polarization direction of the second polarizer 307 are parallel to each other.

Referring to FIG. 3a, in an embodiment of this application, the pixel structure includes the pixel units 300. The pixel units 300 includes a first light penetration area (310, 360), a second light penetration area (320, 350), and a third light penetration area (330, 340). A combination basis of the three areas is distinguishing pixel units effects according to different depths and an area ratio.

FIG. 3b shows retardations of three types of liquid crystal layers of a pixel structure according to an embodiment of this application. In an embodiment of this application, the first pixel unit 300 may divide a pixel equivalent region into at least three regions by using different gradient terrain factors of retardations (including three retardations 340, 350, and 360).

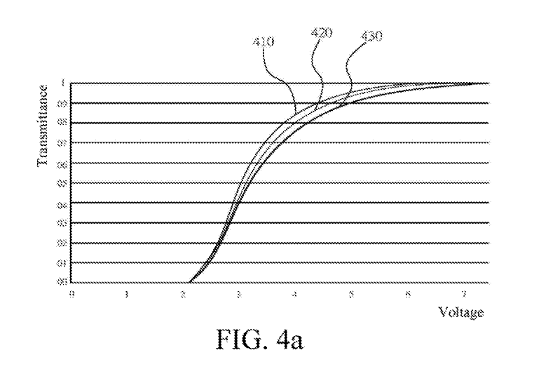

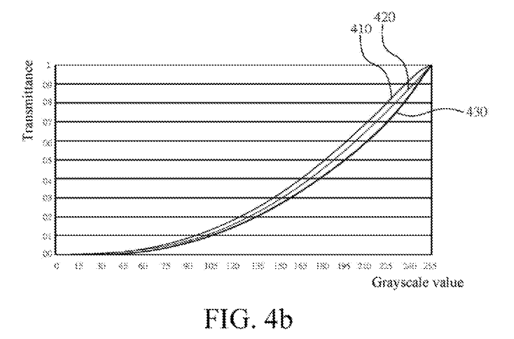

FIG. 4a explains three types of GAMMA curves by using a V-T curve according to an embodiment of this application. Referring to FIG. 4a, FIG. 4a shows a transmittance-voltage value curve 410 corresponding to a 3.6 cell gap, a transmittance-voltage value curve 420 corresponding to a 3.9 cell gap, and a transmittance-voltage value curve 430 corresponding to a 4.2 cell gap.

FIG. 4b explains three types of GAMMA curves by using a transmittance-grayscale value according to an embodiment of this application. Referring to FIG. 4b, FIG. 4b shows a transmittance-grayscale value 410 corresponding to a 3.6 cell gap, a transmittance-grayscale value 420 corresponding to a 3.9 cell gap, and a transmittance-grayscale value 430 corresponding to a 4.2 cell gap.

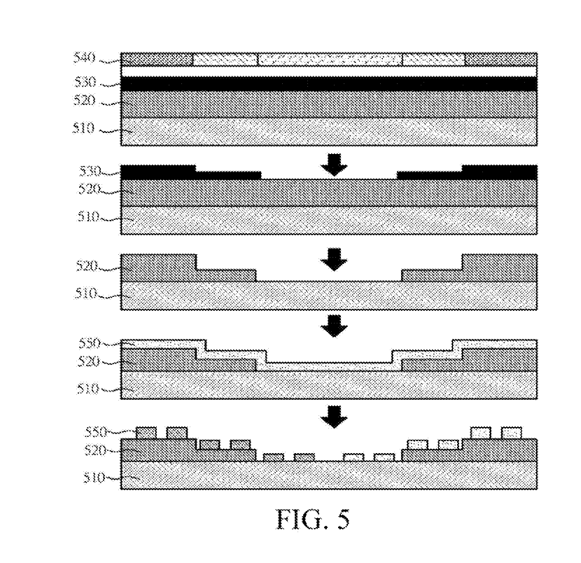

FIG. 5 is a schematic diagram of manufacturing a pixel structure in a gradient shape by using a half tone process procedure according to this application. Referring to FIG. 5, in an embodiment of this application, an etching process of the passivation layer is changed by using the half tone process procedure. Moreover, pixel distinguishing effects are caused by using different gradient terrains within a liquid crystal box, so as to replace a conventional voltage division manner. For example, the first substrate has a four-layer structure and includes: a transparent substrate (SB) layer 510, a passivation layer 520, a photoresist (PR) layer 530, and an indium tin oxide (ITO) layer 550. Moreover, a film forming step, an exposure step, a developing step, an etching step, and a film stripping step need to be performed, and the procedure needs to be repeated for five times to complete the substrate. The film forming step is laying a thin film of a required material (the passivation layer 520, the photoresist material layer 530, and the indium tin oxide layer 550) on a glass substrate 510. The explosion step is using a photomask 540 on the photoresist 530 to develop a required photoresist 530 pattern. The developing step is leaving the photoresist 530 of the photoresist 530 pattern part at a previous stage. The etching step is etching a required pattern on the substrate 510 on which the photoresist 530 already exists. The film stripping step is removing the photoresist 530 covering the pattern by using the substrate 510 on which the required pattern has been etched, so as to perform subsequent projects.

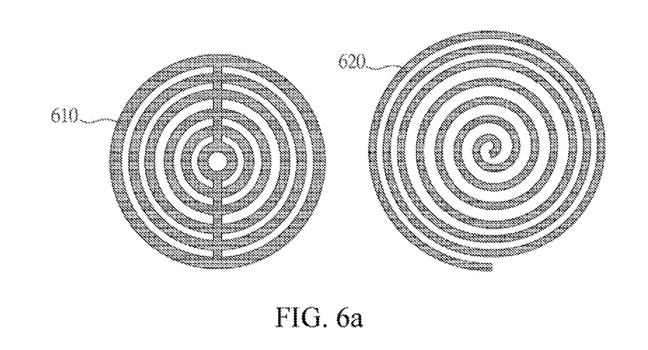

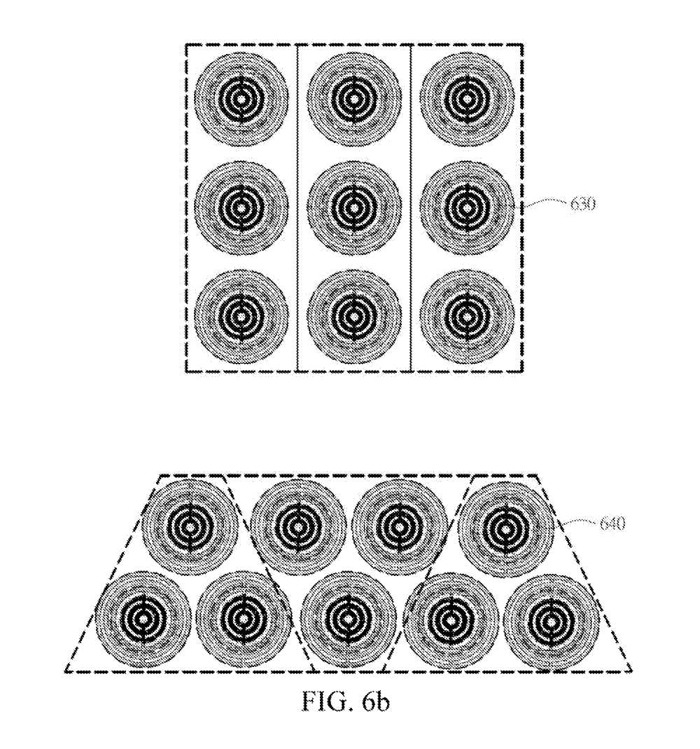

FIG. 6a is a schematic diagram of an electrode pixel shape according to an embodiment of this application. Referring to FIG. 6a, in an embodiment of this application, the shape of a pixel structure is a circle 610, a helical shape 620, or another shape.

FIG. 6b is a schematic diagram of an arrangement manner of a pixel structure according to an embodiment of this application. Referring to FIG. 6b, in an embodiment of this application, an arrangement manner of the pixel structure is a strip-shaped 630 arrangement, a delta-shaped 640 arrangement, or an arrangement in another shape.

In an embodiment of this application, the pixel of the display device further includes an active switch, for example, a thin film transistor, used to drive the entire pixel.

In an embodiment of this application, an arc-shaped pixel structure may be a circle or an ellipse.

By means of design of an arc-shaped pixel electrode, in this application, a large viewing angle contrast may be alleviated, and a large viewing angle color shift problem of the liquid crystal display panel may be effectively resolved.

Wordings, such as “in some embodiments” and “in various embodiments”, are repeatedly used. The wordings usually do not refer to same embodiments, but the wordings may refer to same embodiments. Words, such as “comprise”, “have”, and “include” are synonyms, unless other meanings are indicated in the context.

The above descriptions are merely preferred embodiments of the present invention, and are not intended to limit this application in any form. Although this application has been disclosed above through the preferred embodiments, the embodiments are not intended to limit this application. Persons skilled in the art can make some equivalent variations, alterations or modifications to the above-disclosed technical content without departing from the scope of the technical solutions of this application to obtain equivalent embodiments. Any simple alteration, equivalent change or modification made to the above embodiments according to the technical essence of this application without departing from the content of the technical solutions of this application shall fall within the scope of the technical solutions of this application.

What is claimed is:

1. A pixel structure, comprising:
a plurality of pixel units, wherein each of the pixel units comprises at least one light penetration area, a light penetration effects of the pixel units are distinguished according to different retardations and an area ratio, and a shape of the pixel structure is a circle, an ellipse, or a helical shape.

2. The pixel structure according to claim 1, wherein the pixel units divide a pixel unit equivalent region into at least three regions by using different phase difference factors.

3. The pixel structure according to claim 1, wherein the pixel units divide a pixel unit equivalent region into at least three regions by using different gradient terrain factors of a passivation layer.

4. The pixel structure according to claim 1, wherein an etching process of the passivation layer is changed by using a half tone process procedure.

5. The pixel structure according to claim 1, wherein the light penetration area comprising a first light penetration area comprising four primary light penetration areas, a second light penetration area comprising four secondary light penetration areas, and a third light penetration area comprising four secondary two-light penetration areas.

6. The pixel structure according to claim 3, wherein the pixel units are divided into three different gradient terrain depths and divide the pixel structure according to the three different gradient terrain depths into an inner layer, a middle layer, and an outer layer that are all circular, a pixel electrode covers on the pixel structure, and design of a slit is reserved.

7. The pixel structure according to claim 1, wherein an arrangement manner of the pixel structure is a strip-shaped arrangement or a delta-shaped arrangement.

8. The pixel structure according to claim 1, further comprising a thin film transistor, used to drive the entire pixel.

9. A liquid crystal display panel, comprising:
a first substrate;
a second substrate, disposed opposite to the first substrate;
a liquid crystal layer, disposed between the first substrate and the second substrate;
a first polarizer, disposed on an outer surface of the first substrate, and a second polarizer, disposed on an outer surface of the second substrate, wherein a polarization direction of the first polarizer and a polarization direction of the second polarizer are parallel to each other; and
a pixel structure, disposed between the first substrate and the second substrate, wherein the pixel structure comprises a plurality of pixel units, each of the pixel units comprises at least one light penetration area, a light penetration effects of the pixel units are distinguished according to different retardations and an area ratio, and a shape of the pixel structure is a circle, an ellipse, or a helical shape.

10. The liquid crystal display panel according to claim 9, wherein the pixel units divide a pixel unit equivalent region into at least three regions by using different phase difference factors.

11. The liquid crystal display panel according to claim 9, wherein the pixel units divide a pixel unit equivalent region into at least three regions by using different gradient terrain factors of a passivation layer.

12. The liquid crystal display panel according to claim 9, wherein an etching process of the passivation layer is changed by using a half tone process procedure.

13. The liquid crystal display panel according to claim 9, further comprising a first light penetration area comprising four primary light penetration areas, a second light penetration area comprising four secondary light penetration areas, and a third light penetration area comprising four secondary two-light penetration areas.

14. The liquid crystal display panel according to claim 9, wherein the pixel units are divided into three different gradient terrain depths and divide the pixel structure according to the three different gradient terrain depths into an inner layer, a middle layer, and an outer layer that are all circular, a pixel electrode covers on the pixel structure, and design of a slit is reserved.

15. The liquid crystal display panel according to claim 9, wherein an arrangement manner of the pixel structure is a strip-shaped arrangement.

16. The liquid crystal display panel according to claim 9, wherein an arrangement manner of the pixel structure is a delta-shaped arrangement.

17. The liquid crystal display panel according to claim 9, further comprising a thin film transistor, used to drive the entire pixel.

18. A pixel structure, comprising:
a plurality of pixel units, wherein each of the pixel units comprises at least one light penetration area, and a light penetration effects of the pixel units are distinguished according to different retardations and an area ratio, and a shape of the pixel structure is a circle, an ellipse, or a helical shape;
the pixel units divide a pixel unit equivalent region into at least three regions by using different phase difference factors;
the pixel units divide a pixel unit equivalent region into at least three regions by using different gradient terrain factors of a passivation layer;
the pixel units are divided into three different gradient terrain depths and divide the pixel structure according to the three different gradient terrain depths into an inner layer, a middle layer, and an outer layer are all circular, a pixel electrode covers on the pixel structure, and design of a slit is reserved; and
an arrangement manner of the pixel structure is a strip-shaped arrangement or a delta-shaped arrangement.
